(19) United States
(12) Patent Application Publication
(10) Pub. No.: US 2016/0292598 A1
(43) Pub. Date: Oct. 6, 2016

(54) Analytics Virtualization System

(71) Applicants: Vishal Kumar, Nashua, NH (US); Sachin Kumar Bhate, Abington, MA (US)

(72) Inventors: Vishal Kumar, Nashua, NH (US); Sachin Kumar Bhate, Abington, MA (US)

(73) Assignee: Vishai Kumar, Nashua, NH (US)

(21) Appl. No.: 14/678,993

(22) Filed: Apr. 5, 2015

(51) Int. Cl. G06Q 10/06; G06F 17/10; G06F 17/50

(52) U.S. Cl. CPC G06Q 10/067; G06Q 10/063; G06F 17/5009; G06F 17/10

(57) ABSTRACT

Analytics Virtualization is a system and method for bridging data and readily usable autonomous computational model based applications using one to many, many to one and many to many relationship. A generalized system is created that allows any data contained virtualized folder to utilize any number of computational model application via a centralized facilitator framework. Framework could be standalone or comprising of network of devices. Devices include but not limited to computers, notebook, tablet, handhelds, smartphones or a custom electronic device. The centralized facilitator framework, acting as a bridging and controlling agent carries all the logistical information that helps connect appropriate data carrying virtual folder with relevant computational model application. This creates an analytics virtualization system that connects right data silos to the right computation model without having them present at the same physical location.

### BACKGROUND OF THE INVENTION

1. Field of the Invention

The present invention relates to a system and method of applying ready to use computational models packed as an autonomous executable application on the data that is connected via a virtualization layer to the computational area for better scalability and faster analytics deployment and run.

2. Description of the Related Art

Before we understand the current state and future of analytics, we should spend some time understanding first recorded use of analytics system. Yes, analytics as a business process has its root since the day business practice was invented during medieval times. The first functioning system to use power of analytics is attributed to Lyons bakery.

In 1951, the J. Lyons company, famous for their tea-shops throughout the UK, built and used the LEO “Lyons Electronic Organizer” computer they had built to run the very first business application ever: bakery valuations.

According to the official LEO archive, the application was: “a valuation of the bread, cakes and pies produced in a dozen Lyons' bakeries for their assembly and dispatch to retail and wholesale channels. It integrated three different tasks that hitherto had been carried out separately: it valued output from each bakery at standard material, labor and indirect costs, as well as total factory costs; it valued issues to the different channels at standard factory cost, distribution cost, sales price and profit margin; and calculated and valued dispatch stock balances for each item.”

Analytics system has evolved a lot since then. With modernization of computing facilities and advances in mathematical and computational world. The marriage of the two has produced several sophisticated ways to do advance analytics in a faster, cheaper and effective manner for research and businesses. Our current capability to analyze has reached the sophistication of using hundreds of thousands of computational ways on enormous amount of data to gain crispier and more accurate insights.

Our incremental capability to digest more data for analytics has demanded more data production. This production has grown to the level of enormity that we've had to coin the term Big Data, signifying the quantity and quality of data that is beyond the reach of current systems. This big data in turn has suddenly demanded more ways to analyze it. One problem or inefficiency or vulnerability that has stayed with analytics system is the involvement of people to analyze the data and less use of analytics systems working as autonomous system to handle data analytics. The cultural shift in data analytics community has introduced several highly sophisticated analytics computing system majorly driven by manual intervention but less autonomous automated computational application that mimic LEO's attempt to analyze business data for decisions. With growing data and inability for computational experts to catch up will increase the divide between the talent and system capability to handle the growing data whereas the data will keep on increasing beyond the point of growing computational capabilities.

In addition to the inability to provide substantial talent pool to catch up with growing data, there is also an inherent vulnerability that exists today in terms of restricted ability to use multiple systems collaboratively to analyze business data. This has tightly locked the computational experts to computational frameworks instead of computational abilities.

Thus, there is an inherent need to build a framework which not only provides a better analytics system that could function autonomously with least amount of human intervention. The ideal system should be able to add scale, speed and accuracy without

This invention is an approach towards virtualizing the analytics. For an effective virtualized analytics system the invention should be able to scales well, fast to respond to business needs, makes use of existing systems, utilizes third party tools as well as custom solutions and complements current business processes.

The big data and analytics industry requires a radical shift in thinking towards analytics systems. A great solution is the one that complements data science capabilities instead of providing yet another solution for doing data analytics. Therefore a true scalable system should accept, appreciate and connect the isolation of business, computational model and data warehouses.

Current invention provides a framework that complements age old data science architecture in any business. It creates a seamless, scalable, and automatable layer between three core analytics driver business functions: business, computational model and data warehouses.

The invention constitutes 4 major components:

1. Virtual Folder System: Synonymous to data containers that bring data in the system for analysis. This module could be one big or several smaller groups of folders which are either co-located or distributed across several locations or part of other virtual systems. These folders could also be database or data warehouse adapters that are bringing database feeds or streams to the analytics virtualization systems. Data concerned could range from a structured or unstructured form, a binary file and/or an open standard to closed standard form.
2. Computational Model Application System: Synonymous to autonomous ready to routines along with the information to call right interpreter to run respective models. It has capabilities for users to manually or automatically deploy more filters and subroutines for some custom analysis. Even the reporting form and templates could be perceived as another form of computational model application. Similar to virtual folder systems, computational model application system could be co-located or distributed across several systems. They could also be applied in series and/or in parallel with other computational model applications to conform to miscellaneous workflows.
3. Dashboard System: An Input/Output interface for user interactions. The function of this system is to acquire the parameters required for proper functioning of the entire analytics virtualization system. It will also be used as a display for system component output for further data mining. The Dashboard system will act as a primary system interface available to users.
4. Virtualization Enabler System: This is the heart of the analytics virtualization system. It's the core engine and a primary module that works with other modules to make analytics virtualization happen. This module connects data from virtualization folder to analytics from computational model application and displays output via dashboard, where dashboard is used to capture parameters as well for the configuration of the system.

Collaboratively, these four core functional modules provide a data science capability that works with any data analytics division of a business without the need to radically change traditional industry practices. This capability makes this invention important and crucial to the businesses. There will also be use cases where these 4 fundamental components works in collaboration with multiple instances of these 4 components to build an analytics virtualization system.

channel analysis, security/intelligence extensions, operations analysis, and data warehouse optimizations. This wide array of use cases could be delivered via analytics virtualization system using adequate number of virtualization folder stitched with right number of computational model applications used in series as well as in parallel. Series of scheduler, triggers, alarms and slew of other function modules play an important role in making sure the data analytics lifecycle is realized with minimum manual interventions.

This analytics virtualization system mimics the current business verticals, which collaborates to implement the data science capabilities to create an automatable replica of a system that is agile, supports quick turnaround, does not restrict user to a particular system or capability, and provides an adapter for any third party applications out there.

### BRIEF DESCRIPTION OF THE DRAWINGS

FIG. 1. is a block diagram illustrating the analytics virtualization system core components.

FIG. 2. is a block diagram illustrating the architectural design for dashboard system used as Input/output module.

FIG. 3. is a block diagram illustrating Computation Model Application System used in Analytics Virtualization Platform for containing autonomous computational models.

FIG. 4. is a block diagram illustrating architectural composition of Computation Model Application which is the building block of Computation Model Application System.

FIG. 5. is a block diagram illustrating the architecture of virtualization folder system used for ingesting data into analytics virtualization system.

FIG. 6. is a block diagram representation of virtualization enabler system that is responsible for core functioning of analytics virtualization system.

FIG. 6b. is representation of virtualization enabler system where more than one virtualization enabler systems are working in unison to deliver analytics virtualization platform.

FIG. 7. is a flowchart representation of one of the core feature showing the configuration of a task in analytics virtualization system.

FIG. 8. is a flowchart representation of core feature of analytics virtualization system, poling for system engagements.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

Exemplary embodiments now will be described fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Embodiments of the present invention provide an approach to virtualize analytics, making it scalable, easy to adapt, cost less, faster deployment and easily blend with other applications. This is yet another opportunity to utilize the diagrammatic description of many important aspect of the invention to understand what the invention encapsulates.

herein are not limited to any particular type of system or architecture. Rather, embodiments of the present invention are capable of being implemented in conjunction with any other type of computing environment now known or later developed.

As stated above in theoretical terms on how the invention will function, here with pictorial view we could spend more time in looking at each important component of this invention and go over how they work in coherence with other neighboring modules to create an analytics virtualization system.

Before we get into the slice and dice of the figures, let us understand what analytics virtualization entails and what it represents. Like any virtualization system, analytics virtualization provides the ability to apply analytics capabilities on data without having analytics models collocate with data locations. Thereby enabling the possibility of applying analytics from any computational model application system to any data source containing virtualization folders placed as further apart or in as close proximity as possible.

At a high level, the invention covered in this patent application comprise of four fundamental components working in unison to make data science possible. These four fundamental components are mentioned in FIG. 1. These four components includes:

Dashboard system (101), Virtualization Enabler System (102), Computational Model Application System (103), and Virtualization Folder System (104)

Wherein, Dashboard System (101), referred to later part of the application as DS, is acting as an interface for providing input and output modules to the analytics virtualization system. Dashboard usage includes but not limited to: configuring an analytics procedure, analyzing current analytics pipeline, analyzing the output obtained from analysis of data. It also facilitates to create, edit, suspend and delete analytics

Virtualization Enabler System (102), referred in later part as VES, is the heart of the system. VES assures the virtualization aspect of analytics work seamless. It also ensures that data is accessed from virtualization folder at the right time, the corresponding computation model applications are accessed and applied on the data, and output reports are generated as and when required. This system will be discussed further in detail later in the document.

Computational Model Application System (103), referred to later part of the text as CMAS, is one of the most important components of this invention. CMAS gives context to the invention and provides computation capabilities through which data is analyzed. CMAS consist of several autonomous computation models. One important aspect of the system is the ability to act autonomously is provided partly by CMAS and partly by virtualization enabler system. This system will be discussed further in detail later in the document.

Virtualization Folder System (104), referred to later part as VFS, is responsible for getting the data to the analytical modules for analysis. Virtualization folder, in broader context, is the ability of this system to hold any data for analysis or signifies the data container. This system will be discussed further in detail later in the document. The background behind using four broad components (DS, VES, CMAS and VFS,) to describe Analytics Virtualization System is in proximity of this system to actual functioning data science operations in any business out there. Data science is an ability/capability of using as much data as possible for analytics towards better decision making. Data science is being used extensively within most businesses today by leveraging manpower using manual ways to do most of enterprise analytics. Our invention is born out of those manual processes and introduces components which could collaboratively create data science architecture similar to data analytics organization, but provide an automatable aspect to it. Thus it provides an easy way to deploy an autonomous and automated data science framework that complements a

In FIG. 1, VES is connected to DS, VFS and CMAS. VES act as the brain and spine for this agile analytics virtualization system. VFS and CMAS works as two arms of the system, one picks the data and other picks the analytics, while DS works as eyes to provide feedback, set the expectations and provide all the valuable inputs and output for proper functioning of this system.

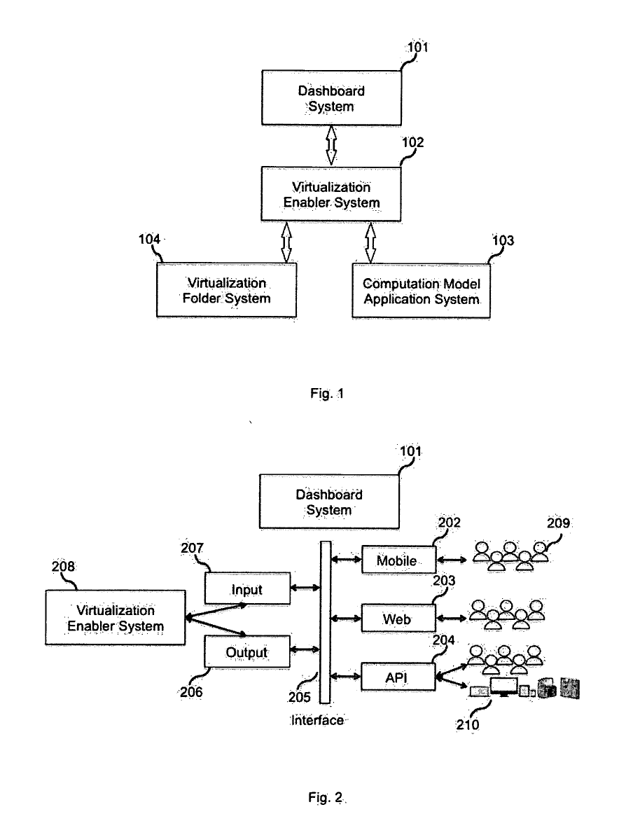

FIG. 2. Explains the Dashboard System (DS, 101). Dashboard system comprises of two broad modules called Input Module (207) and Output Module (206). Input module is responsible for obtaining user inputs for the analytics virtualization system, whereas, output module is used for communicating any relevant information to the user on the output interface provided. In addition, there is an interface (205) between the DS and users and devices for increased outreach. DS interacts with web apps (203), mobile apps (202) and direct APIs (204). With future technological breakthrough, as more ways of interaction emerges, the interface will also be able to encapsulate the upcoming communication channels. Input and output modules at the backend are also connected with Virtualization Enabler System (208). The user could be interacting with the analytics virtualization system via available handheld devices, mobile/web interface and APIs. The primary usage of dashboard is for user to interact with the analytics virtualization system.

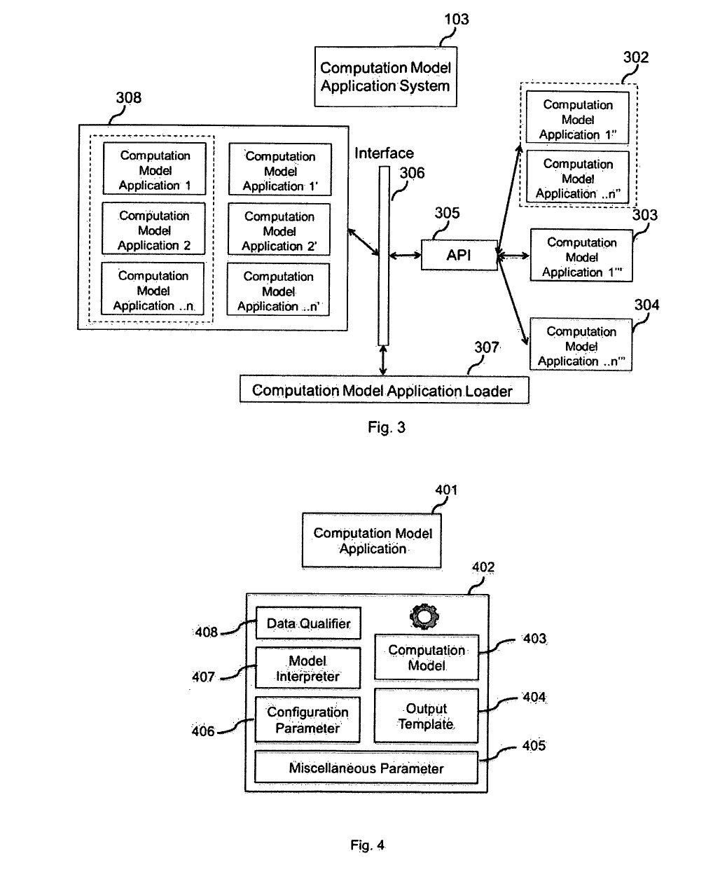

FIG. 3 explains Computation Model Application System (CMAS), a super critical component for analytics virtualization system. CMAS (103) as the name signifies is a collection of computation model applications, which runs on data silos for insight generation. CMAS encapsulates a set of applications that provides automated and autonomous ways to apply computation model on data for analysis. Applications are the building blocks of CMAS, which contains all relevant information to help system run computation models in autonomy. This application could also be viewed as the library of the counter analytics systems that could potentially be deployed quickly, run on its an interface (306). Computation model application could be placed and accessed from computation model application library (308) or directly via API adapter (305). Interface provides a seamless plug between computation model application loader and computation model applications, which as stated could be placed all under one system, or in different systems across different networks across various geo locations. So, computation model application could interact with the application loader via API or a direct call away to the local system.

FIG. 4 explains Computation Model Applications (401), which acts as the building block of Computation Model Application System (CMAS) is nothing but a collection of computation model applications where each application is built to solve a particular use case, and packaged for seamless and automatable access with no external dependencies. Computation model application by definition should be able to contain all relevant information needed for functioning autonomously. One important thing to note here is that computation model application could be a manual process or mix of automated and manual process as well. As a core requirement, the computation model application needs to be self-sufficient with no dependency on any other model. So, ideal model application should contain all relevant information needed for proper functioning. Thus, computation model application consists of information including but not limited to: Computation Model Information (403), Model interpreter (407) information, data qualification rule set, output template (404), miscellaneous parameters (405) and configuration parameters (406) which are important for the proper functioning of this core module. Computation model, as its name suggests, carries the transcript of the model. Similar to computation module, model interpreter carries information regarding the tool, its version, and other information around interpreter application, which will be used to execute the computation model. This opens up the possibility of this invention to interact with other third party tools thereby keeping its framework generic enough to potentially partner with other computing ecosystems for better and effective adaptability.

module is a set of filters, which ensures data is prepped in accordance with computation model. A bad data could result in spurious results therefore data qualifier enables data sanity check before ingested into the computation application module.

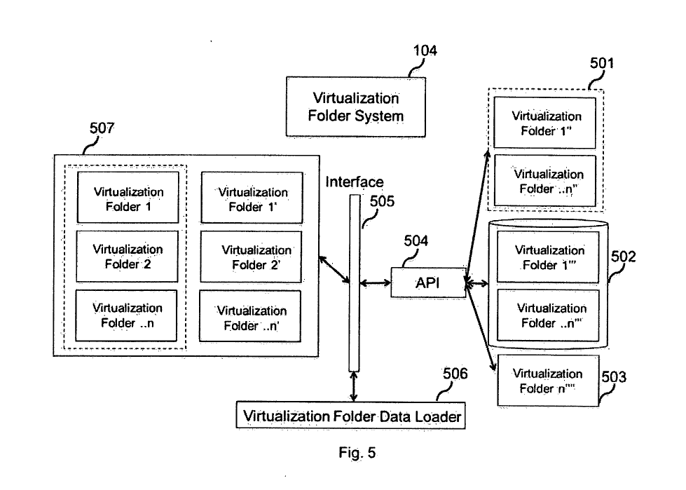

FIG. 5 explains Virtual Folder System (VFS), a super critical component for analytics virtualization system. Virtualization Folder System (103) as the name signifies is a collection of data sources that provides the data to the computation model application for insight generation. Also referred to as VFS, the component encapsulates a set of virtual data sources alias folders providing data for automated and autonomous analysis by computation models for insights. The module that is building block of this component contains all relevant information about the data source and its location. This helps analytics virtualization system in finding the data from the information provided and run computation model application in autonomy. This component could also be viewed as the library of data sources. Virtualization Folder Loader (506) is the core module of this component, which interacts with Virtualization Folders via an interface (505). Data from Virtualization Folder could be accessed from virtualization folder library (507) or directly with virtualization folder sources via API adaptor (504). Interface provides a seamless plug between virtualization folder loader and virtualization folders, which as stated could be placed all under one system, or in different system across different networks across various geo locations. So, virtualization folders could interact with loader via API or a direct call away to the local system. Virtualization folder is synonymous to data container, which could be a physical folder in a system, a virtual folder, and database plug or data warehouse connection.

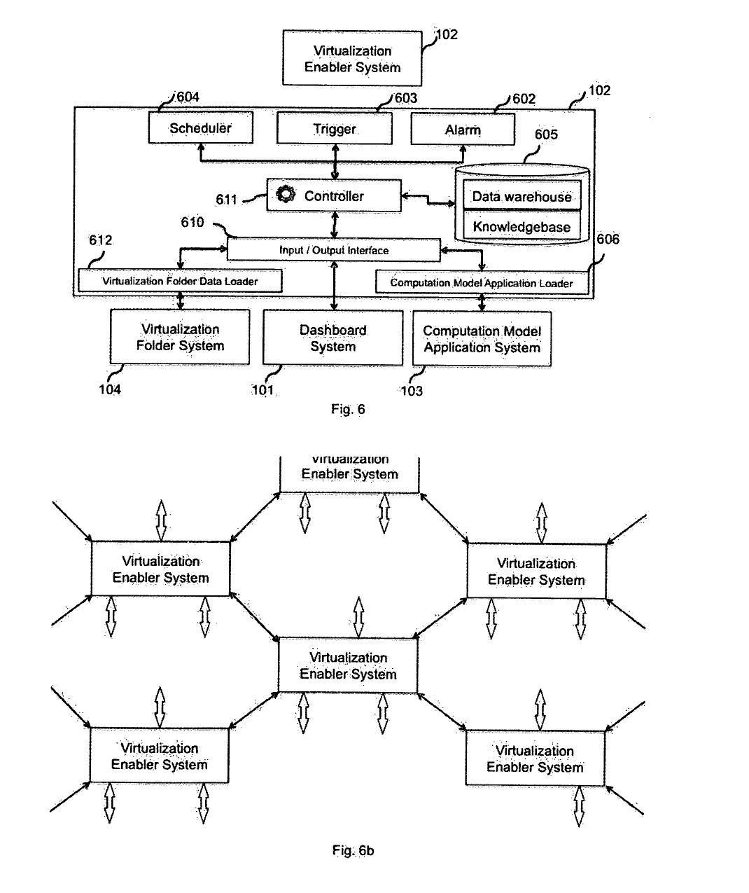

FIG. 6 explains Virtualization Enabler System (VES) is the heart of the analytics virtualization system. VES is a conduit, which connects with other functioning components of analytics virtualization system. It connects with Dashboard Systems (101), Virtualization Folder System (104) and Computation Model Application System Computation Model Application Loader (606) is a module that ensures Computation Models are read properly for flawless execution to analyze data. Controller (611) is the central manager and control function that controls all the dynamic parts of the VES together. VES is equipped with local storage (605) comprising of Data Warehouse and Knowledgebase databases to make sure all the information is stored close to the working arm of Analytics Virtualization System. Controller is also monitors Scheduler (604), Trigger (603) and Alarm (602) modules making sure databases, VFS, CMAS etc. are polled at the right time and appropriate actions are triggered as and when required.

FIG. 6b explains the ability to form multiple virtualization enabler system and connect them together. This provides scalability to the system for a sophisticated architecture and makes it easily distributed across vast areas and multiple domains without losing out on the speed and accuracy.

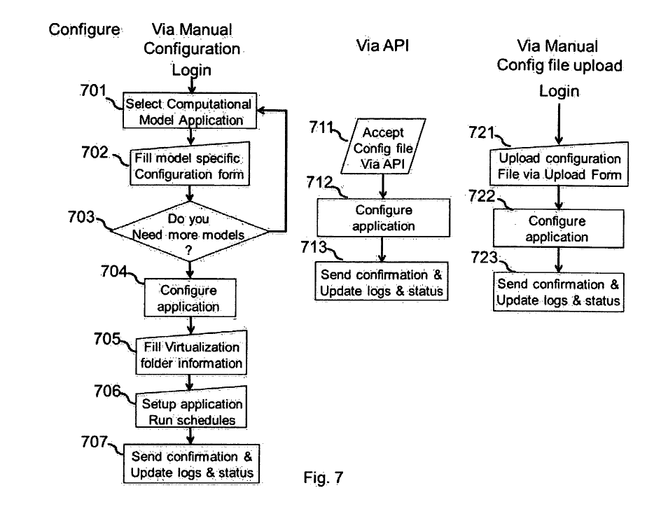

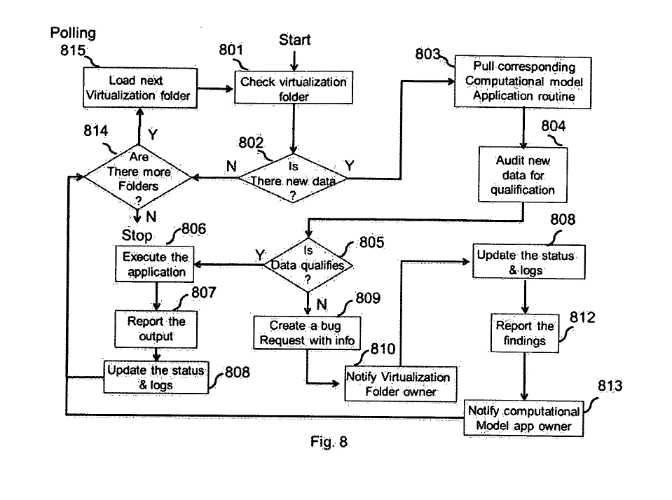

To understand more about the invention FIG. 7 and FIG. 8 mentioned two flowcharts that signify two important workflows for this analytics virtualization system.

FIG. 7. Explains about the ways in which an analytics campaign is created. There are three possible ways to create a campaign: manually going through each step and carefully configuring the campaign, via API call or via configuration file upload through manual channel. In case of step-by-step procedure, typically a user login to the system.

The first task is to pick and choose a computation model application (701) that user is planning to run on their data. Once the user picks any particular computation model application, user will then fill all the relevant details about the application (702) that will help in proper functioning of the application. Each application comes with its own specific form that helps application loader to properly deploy application. Once a user is done with one application, he could go back and add more applications. If (703) user is willing to add more applications, application could be added and same configuration step is repeated. One thing to note here is that several applications are added to work in application. A form is given to user to capture information about their data container (705). This is the place where user signifies if the data is a physical data kept at some folder need to be mapped or an enterprise data warehouse connected with active data warehouse which needs to be pegged. Our system treats virtual folder as a synonymous to data container. So any place where a business keeps its data is treated under the broad category of virtualization folder. Once the folder information is fed, the system then asks for scheduling information and other relevant information needed to run the applications and poll the virtualization folder for data.

The same process of creating analytical campaign could also be done via a configuration file provided via single or multiple API calls, in that case data is accepted via API call (711), application is configured (712) and confirmation and log updates are created and sent (713).

User will also be given an option to add/upload this configuration file manually. On their campaign creation section, users will be given an option to manually upload the configuration file. Once that option is exercised (721), application is configured (722) and confirmation and log updates are created and sent (723).

The polling mechanism is briefly mentioned in our FIG. 8 flowchart. Scheduler and trigger work in harmony to poll all selected virtualization folders in cycles. While checking a virtualization folder (801), if new data is found (802), then system will look for corresponding computation model application associated with the folders are pulled (803). Each computation model application comes with its own way to qualify the incoming data for sanity check before applying computation. So, computation model application qualifies the data (804). If the data qualifies the audit (805), application is executed (806), output is reported (807) as per the terms of configuration when computation model application was configured and applied. Thereby, the logs are qualification logic in computation model audit needs tweaking. So, as soon as the data qualification is failed a system-generated bug is reported which is populated with all the known information about the failure (809). Both Virtualization Folder owner (810) and Computation Model Application owners (813) are notified about the bug number so they could collaborate to fix the issues. A findings report is also generated (812) and logs and statuses are updated (808). This cycle of folder checking is repeated for all the folders that are selected from scheduler module.

There could be other flowchart as well to signify inner functionality of the system which includes but not limited to: creating computation model applications, loading and executing computation model application on data, explaining how data and computation model application work together etc. But it is debatable if applying computation model application as an automated autonomous system could be included as a feature in the entire application interpreter that we will use to execute our invention as well, so we've intentionally kept it out of the patent application. But, once we do more investigation and found exclusive ways, we will add them in our application as we research better way to executed computation model application system.

What is claimed is:

1. An analytics virtualization system which connects data source(s) via virtualization folder with computational model application system consisting of computational model applications without the need of co-location of any system and/or any modeling application, or the need for any particular type of computational model application framework. The underlying centralized facilitator framework that act as manager and controller for bridging and collaborating between data sources and computation model applications is referred to as virtualization enabler system, which comprise of but not limited to relationship information between virtualization folder and computational model application framework, information about virtualization folder, information about computation model applications and system with capabilities to manage, operationalize and control the interaction between virtual folder and computational model application. A dashboard system is also provided that acts as an interface to provide real time or batch input/output interactions for system or business consumption.

2. The method of claim 1, wherein the analytics virtualization system mentioned could either comprises of single or multiple devices acting in a standalone or networked environment. Devices include but not limited to computers, notebook, tablet, handhelds, smartphones or a custom electronic device.

3. The method of claim 1, wherein computational model application framework comprise of computational model applications. Each Computation model application comprises of but not limited to a written model in any computational modeling language, data qualification criteria, data disqualification criteria, input/output modules, filters, triggers, schedules, configuration parameters, model interpreter information and associated documentation and other relevant parameters needed for autonomous functioning of the computational model application.
and control operations by controller, trigger/scheduler framework, master engine, and adapter system. Wherein single virtualization enabler system or a network of multiple virtualization enabler systems works in unison to deliver analytics virtualization system.

5. The method of claim 1, wherein types of virtualization folder include but not limited to: a virtual folder, database adapter, physical folder, data stream adapter, and third party data source connector. Herein, virtualization folder is synonymous to any data container, which is providing data for analysis to the analytics virtualization system. Virtualization folder system comprise of virtualization folders that are collocated and/or distributed across multiple locations.

6. The method of claim 1, wherein virtualization folders and computational model applications modules could be utilized as part of a workflow which could flow in series, parallel or mix across single or multiple virtualization folder systems as well as single or multiple computational model application systems.

7. The method of claim 1, wherein virtualization folders and computational model applications could be connected with each other via one-to-many, many-to-one, and many-to-many relationship.

8. The method of claim 1, wherein an interface is provided for accepting information around areas critical to functioning of analytics virtualization system which includes but not limited to: virtualization folder, computational model application, user information, and device interactions.

9. The method of claim 1, wherein the analytics virtualization system could be a single instance of dashboard system, virtualization enabler system, virtualization folder system and computation model application system or they are mix of multiple instances of computation model application system working in unison to deliver an analytics virtualization system.

10. The method of claim 1, wherein the functioning modules of analytics virtualization system could be placed all in one location or each module could be distributed across several locations and connected through some predetermined networked channels.

11. The method of claim 1, wherein the dashboard could be used for but not limited to: data mining capabilities, configuring system requirements, booking computational model applications, assigning virtual folder requirements, feeding in parameters of significance that are required for smooth system functioning and configuring personalized experience parameters.

12. The method of claim 2, wherein participating devices could either be interacting with virtualization enabler system via a proprietary software, third party application or web interface.

13. The method of claim 3, wherein the autonomous computational model application system could utilize family of software interpreter, which includes but not limited to: proprietary software, open source software, and hybrid system using mix of both.

14. The method of claim 3, wherein the computational model procedures used to analyze data includes but not limited to automated, manual or mix of automated and manual ways to analyze the data to insights.

15. The method of claim 4, wherein database unit mentioned could be part of a data warehousing system across multiple location or a standalone database.

16. The method of claim 4, wherein, filter triggers and schedules work collaboratively to create triggers to activate analytics computational model application systems for data analysis on relevant virtualization folders.

17. The method of claim 4, wherein adapter system utility in the system includes relevant information to gain access to adapters required by analytics virtualization system to make connection with other third-party or remote systems for exchanging information.

18. The method of claim 4, wherein master engine is responsible for operationalizing analytics virtualization software. The roles of master engine includes but not limited to: pulling data from virtualization folder, establish trigger conditions for initiating computational model application execution for data processing, initiate and execute computational model application run on the data, report any findings, update run statistics, perform user access audits.

19. The method of claim 4, wherein the information types used in database unit includes but not limited to: virtualize folder system, computational model application system, and relationship information between data sources and associated computational model application system, master data information.
